(19) United States
(12) Patent Application Publication
(10) Pub. No.: US 2024/0320553 A1
(43) Pub. Date: Sep. 26, 2024

(54) LEARNING DEVICE, LEARNING METHOD, AND STORAGE MEDIUM

(71) Applicant: HONDA MOTOR CO., LTD., Tokyo (JP)

(72) Inventors: Sho Nakajima, Wako-shi (JP); Atsushi Yamamoto, Wako-shi (JP); Jun Okano, Wako-shi (JP)

(21) Appl. No.: 18/582,712

(22) Filed: Feb. 21, 2024

(30) Foreign Application Priority Data
Mar. 20, 2023 (JP) 2023-044233

(51) Int. Cl. G06N 20/00

(52) U.S. Cl. CPC G06N 20/00

(57) ABSTRACT

A learning device includes a processor configured to execute a program to generate learning source data by classifying product data, which includes a plurality of data sets that are pairs of explanatory variables indicating product materials or design matters and target variables indicating performance of the product, into each predetermined classification, distribute the learning source data into training data and verification data, generate a machine learning model on the basis of the training data, and compare a target variable included in the verification data and a target variable predicted by the machine learning model on the basis of explanatory variables of the verification data. The processor is configured to execute the program to distribute the learning source data to make a proportion of a data set for each classification in the learning source data correspond to a proportion of the data set for each classification in the training data and a proportion of the data set for each classification in the verification data.

### CROSS-REFERENCE TO RELATED APPLICATION

Priority is claimed on Japanese Patent Application No. 2023-044233, filed Mar. 20, 2023, the content of which is incorporated herein by reference.

### BACKGROUND OF THE INVENTION

### Field of the Invention

The present application relates to a learning device, a learning method, and a storage medium.

### Description of Related Art

Machine learning involves using training data about known cases to find a relationship between factors and results of the cases. Machine learning can be regarded as data processing for obtaining a mathematical model that represents a relationship between explanatory variables that indicate the factors and target variables that indicate the results using a computer. A trained mathematical model (sometimes called a “machine learning model,” “learning model,” “model,” or the like) is used to predict the results based on unknown factors.

Machine learning is applied to various fields, such as product design. In product design, a model for performing prediction using specifications of parts, materials, or the like as explanatory variables and expected performance based on the specifications as target variables is learned. Japanese Unexamined Patent Application, First Publication No. 2020-57261 discloses a multiple regression analysis device that performs a multiple regression analysis on a plurality of data sets composed of a plurality of explanatory variables and target variables.

### SUMMARY OF THE INVENTION

The accuracy of a machine learning model depends on a type and an amount of training data used during learning. In particular, when a machine learning model is used to design a plurality of different product types, it is important that the training data comprehensively include data for a target product type. Furthermore, verification data is used to verify prediction accuracy of the machine learning model after learning, but if this verification data does not comprehensively include data of the target product type, accurate verification cannot be performed. In addition to prediction accuracy from a perspective of a plurality of different product types, it is also necessary to verify the prediction accuracy of each product type.

The embodiments of this application have been made in view of the points described above, and have an object of providing a learning device, a learning method, and a storage medium that can appropriately generate and verify a machine learning model that performs the performance prediction of a plurality of types of products.

The learning device, the learning method, and the storage medium according to the present invention have adopted the following configuration.

(1) A learning device according to one aspect of the present invention includes a processor configured to execute a program to, generate learning source data by classifying product data, which includes a plurality of data sets that are pairs of explanatory variables indicating product materials or design matters and a target variable indicating performance of the product, into each predetermined classification, distribute the learning source data into training data and verification data, generate a machine learning model on the basis of the training data, and compare a target variable included in the verification data and a target variable predicted by the machine learning model on the basis of explanatory variables of the verification data. The processor is configured to execute the program to distribute the learning source data to make a proportion of a data set for each classification in the learning source data correspond to a proportion of the data set for each classification in the training data and a proportion of the data set for each classification in the verification data.

(2) In the learning device according to the aspect of (1) described above, the processor may be configured to execute the program to perform both first verification for all data sets included in the verification data and second verification for the data sets for each classification in the verification data.

(3) In the learning device according to the aspect of (2) described above, the processor may be configured to execute the program to perform the first verification and the second verification using different index values.

(4) In the learning device according to the aspect of (1) described above, the processor may be configured to execute the program to distribute the learning source data to make the proportion of the data set for each classification in the learning source data be equal to the proportion of the data set for each classification in the training data and the proportion of the data set for each classification in the verification data.

(5) In the learning device according to the aspect of (1) described above, the processor may be configured to execute the program to distribute the data set for each classification in the learning source data into the training data and the verification data in a predetermined proportion.

(6) In the learning device according to any one of the aspects of (1) to (5) described above, the processor may be configured to execute the program to classify the product data into classifications determined according to a use of the product.

(7) In the learning device according to any one of the aspects of (1) to (5) described above, the processor may be configured to execute the program to classify the product data into classifications determined according to a shape of the product.

(8) In the learning device according to any one of the aspects of (1) to (5) described above, the processor may be configured to execute the program to classify the product data into classifications determined according to a manufacturing method of the product.

(9) In the learning device according to any one of the aspects of (1) to (5) described above, the processor may be configured to execute the program to calculate a plurality of types of index values using a target variable included in the verification data and a target variable predicted by the machine learning model.

(10) In the learning device according to the aspect of (2) or (3) described above, the processor may be further configured to execute the program to cause a display to display a verification result of the first verification and a verification result of the second verification.

(11) In the learning device according to any one of the aspects of (1) to (5) described above, the product may be a battery.

(12) A learning method according to another aspect of the present invention includes, by a computer, generating learning source data by classifying product data, which includes a plurality of data sets that are pairs of explanatory variables indicating product materials or design matters and target variables indicating performance of the product, into each predetermined classification, distributing the learning source data into training data and verification data, generating a machine learning model on the basis of the training data, and comparing a target variable included in the verification data and a target variable predicted by the machine learning model on the basis of explanatory variables of the verification data, in which the learning source data is distributed to make a proportion of a data set for each classification in the learning source data correspond to a proportion of the data set for each classification in the training data and a proportion of the data set for each classification in the verification data.

(13) A computer-readable non-transitory storage medium according to still another aspect of the present invention stores a program causing a computer to execute generating learning source data by classifying product data, which includes a plurality of data sets that are pairs of explanatory variables indicating product materials or design matters and target variables indicating performance of the product, into each predetermined classification, distributing the learning source data into training data and verification data, generating a machine learning model on the basis of the training data, and comparing a target variable included in the verification data and a target variable predicted by the machine learning model on the basis of explanatory variables of the verification data, in which the program causes the learning source data to be distributed to make a proportion of a data set for each classification in the learning source data correspond to a proportion of the data set for each classification in the training data and a proportion of the data set for each classification in the verification data.

According to the configurations (1) to (13) described above, it is possible to appropriately generate and verify a machine learning model that performs performance predictions of a plurality of types of products.

Moreover, according to the configurations of (2), (3), (9), and (10) described above, in addition to prediction accuracy (overall evaluation) from the perspective of a plurality of different product types, verification of the prediction accuracy of individual product types (individual evaluation) can also be performed. By simultaneously ascertaining accuracy of a correlation relationship across the plurality of product types and accuracy of the correlation of each product type, it is possible to determine the macro accuracy and each micro accuracy of a machine learning model. Furthermore, by using appropriate evaluation indicators for each of an overall evaluation and individual evaluation on the basis of a plurality of evaluation index values, it is possible to appropriately verify the machine learning model.

### BRIEF DESCRIPTION OF THE DRAWINGS

FIG. 1 is a schematic block diagram which shows a configuration example of a learning device according to the present embodiment.

FIG. 2 is a diagram which describes how learning source data OD according to the present embodiment is distributed into training data TD and verification data ID.

FIG. 3 is a diagram which describes a data configuration (the amount of data) of the learning source data OD, the training data TD, and the verification data ID according to the present embodiment.

FIG. 4 is a schematic block diagram which shows a hardware configuration example of the learning device according to the present embodiment.

FIG. 5 is a flowchart which shows an example of a flow of processing of the learning device according to the present embodiment.

FIG. 6 is a diagram which shows an example of a verification result (prediction accuracy information) according to the present embodiment.

FIG. 7 is a diagram which shows another example of the verification result (prediction accuracy information) according to the present embodiment.

### DETAILED DESCRIPTION OF THE INVENTION

A learning device, a learning method, and a storage medium according to an embodiment of the present application will be described with reference to the drawings.

### <Configuration of Learning Device 10>

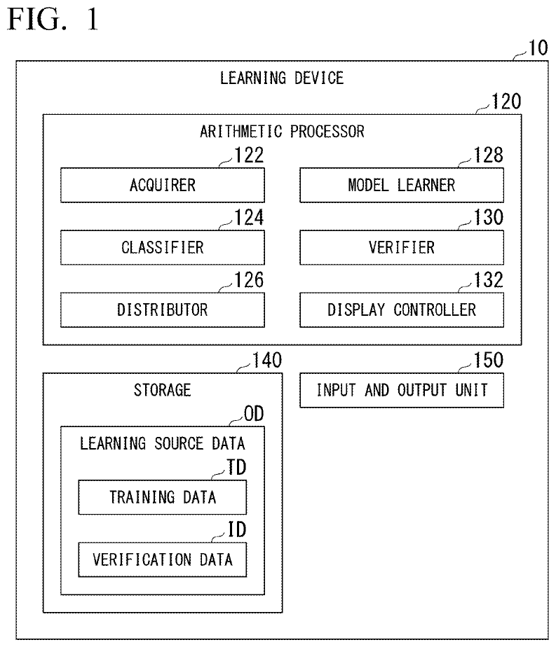

FIG. 1 is a schematic block diagram which shows a configuration example of a learning device 10 according to the present embodiment. The learning device 10 generates a machine learning model that makes it possible to estimate target variables that indicate performance of a product based on a group of explanatory variables that include a plurality of types of explanatory variables that indicate product materials or design matters, and that makes it possible to derive a correlation of the explanatory variables with respect to the target variables. The learning device 10 performs learning processing using training data including a data set consisting of a group of explanatory variables and actual measured values of target variables. Furthermore, the learning device 10 calculates predicted values of the target variables based on the group of explanatory variables using the learned machine learning model using verification data, and calculates prediction accuracy of the calculated predicted values on the basis of the actual measured values of the target variables.

The present embodiment can be applied to products that have dependence based on production requirements such as materials or design matters. The present embodiment can be applied to such a product, for example, a battery (also called a storage battery or secondary battery that can be repeatedly charged or discharged). When a product to be processed is a battery, for example, some or all items, such as materials of an electrode (material design) or a blending ratio of a plurality of types of materials (production technology design), a length of an electrode, and a thickness (shape) of an electrode are included in the group of explanatory variables. As an index of performance given to the group of explanatory variables, for example, a capacity, an output, a cost, and the like are each applied as target variables. A capacity corresponds to a charge discharged from a start of discharge until an end voltage is reached when an output voltage between two poles is a rated voltage. An output corresponds to a current or power obtained by discharge when an output voltage is equal to the rated voltage. A cost is a cost of manufacturing a corresponding product. The cost may include various expenses required for processing, distribution, and the like in addition to a unit price of each member.

The learning device 10 includes, for example, an arithmetic processor 120, a storage 140, and an input and output unit 150. The arithmetic processor 120 includes, for example, an acquirer 122, a classifier 124, a distributor 126, a model learner 128, a verifier 130, and a display controller 132.

The acquirer 122 acquires product data indicating characteristics of each product. The product data includes data corresponding to a plurality of types of products. The product data includes a plurality of data sets for each product. Each data set includes production information and performance information. The production information includes one or more items of variables that indicate information on one or both of product materials and design matters. The performance information includes one or more items of an actual measured value of the performance of a product produced according to production information included in a data set common to the performance information. That is, product data includes a plurality of data sets that are pairs of explanatory variables that indicate product materials or design matters and target variables that indicate the performance of a product.

The acquirer 122 acquires product data from, for example, a predetermined external device. External devices include, for example, a database that stores product data, a server device, a personal computer, a dedicated measuring instrument, and the like. The acquirer 122 may acquire product data input by a user via an operation input unit 158, which will be described below. Alternatively, the product data is stored in a removable storage medium such as a USB, a DVD, or a CD-ROM, and the acquirer 122 may acquire the product data by attaching this storage medium to a drive device provided in the learning device 10.

The classifier 124 classifies the acquired product data for each predetermined classification (a product type) to generate learning source data OD. The classifier 124 stores the generated learning source data OD in the storage 140. A product type is a classification that is set depending on a use, such as a product for smartphones, a product for vehicles, or a product for small devices. Alternatively, the product type is a classification set depending on a manufacturing method, such as a mass-produced product, a trial product, or a recycled product obtained by dismantling other devices. In addition, the product type may be, for example, a classification set according to a shape, such as a square shape, a cylindrical shape, or a lamination shape. The product type is not limited to these, and any classification can be set depending on a purpose. The product data acquired by the acquirer 122 includes information indicating this product type. The classifier 124 performs classification processing by, for example, assigning a classification (for example, a sample name) based on the product type to each data set included in the acquired product data.

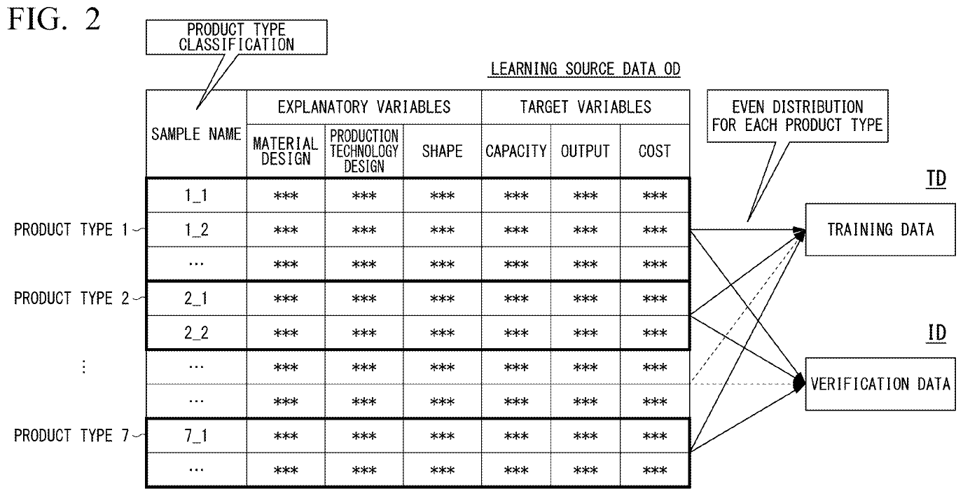

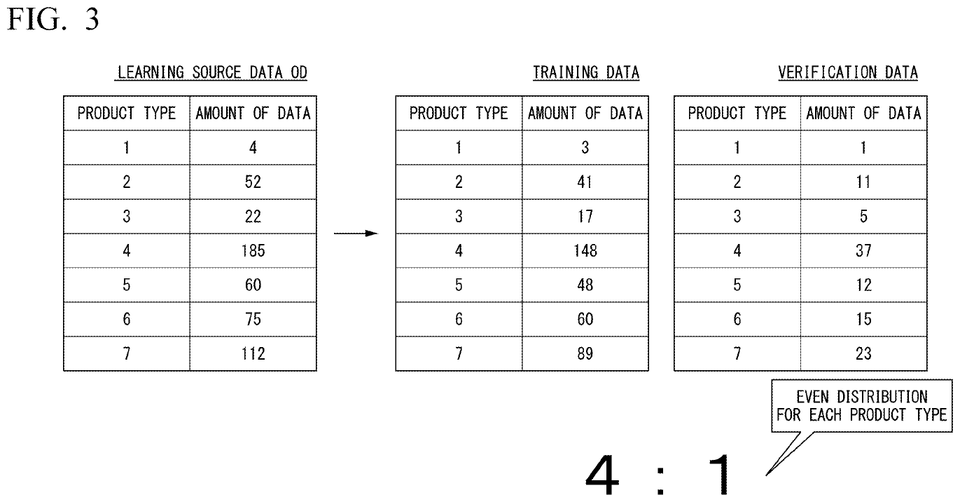

The distributor 126 distributes the learning source data OD into training data and verification data on the basis of a classification given by the learning source data OD. The distributor 126 stores the distributed training data and verification data in the storage 140. FIG. 2 is a diagram which describes how the learning source data OD according to the present embodiment is distributed into training data TD and verification data ID. As shown in FIG. 2, in the learning source data OD, items serving as explanatory variables and items serving as target variables are associated with a sample name (a classification). For example, the sample name has a format of “type number_serial number.” In other words, in an example in FIG. 3, a data set with a sample name in a format “1_” corresponds to a product type 1, a data set in a format “2_” corresponds to a product type 2, and a data set in a format “n_” corresponds to a product type n.

FIG. 3 is a diagram which describes a data configuration (the amount of data) of the learning source data OD, the training data TD, and the verification data ID according to the present embodiment. As shown in FIG. 3, the distributor 126 distributes (evenly distributes) the learning source data OD into the training data TD and the verification data ID so as to hold a proportion of a data set for each product type in the learning source data OD on the basis of a sample name (a classification). That is, a ratio of the amount of data of seven types, such as the amount of data of a product type 1 (4), the amount of data of a product type 2 (52), the amount of data of a product type 3 (22), the amount of data of a product type 4 (185), the amount of data of a product type 5 (60), the amount of data for a product type 6 (75), and the amount of data for a product type 7 (112) in the learning source data OD is the same as a ratio of the amount of data of seven types in the training data TD and a ratio of the amount of data of seven types in the verification data ID. Note that the data set for each product type of the learning source data OD is distributed into the training data TD and the verification data ID in a predetermined proportion. In the example shown in FIG. 3, the data set is distributed such that the number of training data TD and the number of verification data ID have a ratio of approximately “4:1” for each product type. This predetermined proportion is arbitrary. Note that when the number of data sets is small or cannot be divided in a predetermined proportion, the number of distributions is appropriately determined so as to be close to this proportion. That is, the distributor 126 distributes the learning source data OD such that the proportion of a data set for each classification in the learning source data OD corresponds to the proportion of a data set for each classification in the training data TD and the proportion of a data set for each classification in the verification data ID. In the present embodiment, a term “corresponding” includes a configuration in which the proportion of a data set for each classification in the learning source data OD is equal to the proportion of a data set for each classification in the training data TD and the proportion of a data set for each classification in the verification data ID as well as a configuration in which both are substantially equal to each other.

Returning to FIG. 1, the model learner 128 performs learning processing using the training data TD to generate a machine learning model. The model learner 128 uses explanatory variables of a data set included in the training data TD as an input, and performs learning processing such that an evaluation value of a predetermined loss function that indicates a magnitude of a difference between predicted values (model outputs) of target variables calculated using the learning model and actual measured values of target variables included in the training data TD decreases as a whole of the training data. The model learner 128 determines whether learning has converged based on whether the evaluation value of the loss function is equal to or less than a predetermined reference value. When the model learner 128 determines that the learning has converged, it stops the learning and stores in the storage 140 a learned parameter set (a machine learning model) indicating the parameter set obtained at that time.

Types of machine learning models are broadly classified into, for example, models related to linear regression and models related to nonlinear regression. Linear regression is a statistical method that assumes that a model showing a relationship between explanatory variables and target variables is a linear prediction function, and clarifies the relationship. In the present embodiment, regression analysis methods such as a multiple regression analysis, ridge regression (Ridge), least absolute shrinkage and selection operator (LASSO) regression, and elastic net are applicable as methods related to linear regression. Nonlinear regression refers to a statistical method that uses a mathematical model showing a nonlinear relationship between explanatory variables and target variables, and clarifies the relationship. Known methods such as support vector machine (SVR), neural network, Adaboost, gradient boosting, and random forest are applicable as mathematical models related to nonlinear regression.

The verifier 130 performs verification on the machine learning model using the verification data ID stored in the storage 140. The verifier 130 performs verification on the prediction accuracy by comparing the predicted values (model outputs) of the target variables calculated using the machine learning model and the actual measured values of the target variables included in the verification data. For each data set included in the verification data, the verifier 130 calculates the predicted values of the target variables based on a group of explanatory variables included in a corresponding data set using the machine learning model. The verifier 130 calculates the magnitude of the difference between the calculated predicted values and the actual measured values, that is, an index value (score) indicating the prediction accuracy. The verifier 130 aggregates the calculated index values of the prediction accuracy and generates prediction accuracy information indicating the aggregated prediction accuracy.

The verifier 130 may use, for example, statistic of any one of a coefficient of determination (R²), a mean square error (MSE), a root mean square error (RMSE), a mean absolute error (MAE), a mean absolute percentage error (MAPE), a symmetric mean absolute percentage error (SMAPE), a maximum error ratio (MER), and the like, as an index value.

A coefficient of determination R², a mean square error MSE, a root mean square error RMSE, a mean absolute error MAE, a mean absolute percentage error MAPE, a symmetric mean absolute percentage error SMAPE, and a maximum error ratio MER are calculated using Equations (1), (2), (3), (4), (5), (6), and (7), respectively. In Equations (1) to (7), yᵢ indicates the actual measured values of the target variables in a data set i. yᵢ\hat{ } indicates the predicted values of the target variables in a data set i. n is a predetermined integer of 2 or more indicating the number of data sets used for accuracy verification.

$$\begin{matrix}[ Math 1 ] & \\ {R}^{2} = 1 - \frac{{\sum }_{i = 1}^{n} {( {y}_{i} - {\hat{y}}_{i} )}^{2}}{{\sum }_{i = 1}^{n} {( {y}_{i} - \overline{y} )}^{2}} & ( 1 )\end{matrix}$$

$$\begin{matrix}[ Math 2 ] & \\ MSE = \frac{1}{n} {\sum }_{i = 1}^{n} {( {y}_{i} - {\hat{y}}_{i} )}^{2} & ( 2 )\end{matrix}$$

$$\begin{matrix}[ Math 3 ] & \\ RMSE = \sqrt{\frac{1}{n} {\sum }_{i = 1}^{n} {( {y}_{i} - {\hat{y}}_{i} )}^{2}} & ( 3 )\end{matrix}$$

$$\begin{matrix}[ Math 4 ] & \\ MAE = \frac{1}{n} {\sum }_{i = 1}^{n} \vert {y}_{i} - {\hat{y}}_{i} \vert & ( 4 )\end{matrix}$$

$$\begin{matrix}[ Math 5 ] & \\ MAPE ( \% ) = \frac{100}{n} {\sum }_{i = 1}^{n} \vert \frac{{y}_{i} - {\hat{y}}_{i}}{{y}_{i}} \vert & ( 5 )\end{matrix}$$

$$\begin{matrix}[ Math 6 ] & \\ SMAPE ( \% ) = \frac{100}{n} {\sum }_{i = 1}^{n} \vert \frac{( {y}_{i} - {\hat{y}}_{i} )}{( \vert {y}_{i} \vert - \vert {\hat{y}}_{i} \vert )} \vert & ( 6 )\end{matrix}$$

$$\begin{matrix}[ Math 7 ] & \\ MER ( \% ) = 100 \times max \vert \frac{{y}_{i} - {\hat{y}}_{i}}{{y}_{i}} \vert & ( 7 )\end{matrix}$$

The coefficient of determination R² is a real value between 0 and 1, and indicates a higher prediction accuracy as it is closer to 1. In general, the coefficient of determination tends to approximate 1 as the number of elements of explanatory variables that are elements of the group of explanatory variables increases.

The mean square error MSE is a real value of 0 or more, and indicates a higher prediction accuracy as it is closer to 0. A mean square error represents a magnitude of an error as a whole of the target variables more easily than a mean absolute error.

The root mean square error RMSE corresponds to a square root of the mean square error, and an increase in its absolute value is suppressed more than the mean square error. The root mean square error is often used in prediction evaluation of regression problems.

The mean absolute error MAE is a positive real value of 0 or more, and indicates a higher prediction accuracy as it is closer to 0. Since the mean absolute error is proportional to a width of an error of each target variable, it tends to be easily affected by an outlier of each target variable.

The mean absolute percentage error MAPE has a real value of 0 or more, and indicates a higher prediction accuracy as it is closer to 0%. The mean absolute percentage error indicates an absolute deviation as a whole of explanatory variables. Since the mean absolute percentage error is proportional to a proportion of an error to the actual measured value of each explanatory variable, it tends to be easily affected by an error rate of each explanatory variable. In addition, the predicted value of each explanatory variable is normalized by dividing it by the actual measured value, so it cannot be used if the actual measured value contains zero.

The symmetric mean absolute percentage error SMAPE has a real value of 0 or more, and indicates a higher prediction accuracy as it is closer to 0%. The symmetric mean absolute percentage error is given by using a difference between an absolute value of the actual measured value and an absolute value of the predicted value instead of the actual measured value in the mean absolute percentage error. The symmetric mean absolute percentage error can be used as long as the difference between the absolute value of the actual measured value and the absolute value of the predicted value is not zero even if the actual measured value contains zero.

The maximum error ratio MER has a real value of 0 or more, and indicates a higher prediction accuracy as it is closer to 0%. A maximum error ratio corresponds to a maximum value of a ratio of an absolute value of the difference between the actual measured value and the predicted value to the absolute value of the actual measured value of each explanatory variable. For this reason, errors in specific explanatory variables are easily represented.

In this manner, an index value has unique characteristics. Types of an index value to be calculated may be determined in advance for each target variable to be calculated. Moreover, types of the index value to be calculated may be determined in advance for each product type (classification) to be calculated.

The verifier 130 may calculate a plurality of types of index values using a target variable included in the verification data ID and a target variable predicted by the machine learning model. The verifier 130 may perform both first verification for all data sets included in the verification data ID and second verification for data sets for each classification in the verification data ID. The verifier 130 may perform the first verification and the second verification using different index values.

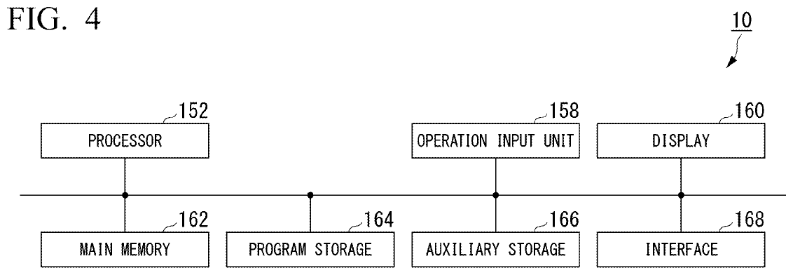

The display controller 132 causes the display 160 (FIG. 4), which will be described below, to display a result of the verification (prediction accuracy information) input from the verifier 130. For example, the display controller 132 generates a display screen by disposing prediction accuracy information according to a predetermined screen layout, and outputs display data indicating the generated display screen to the display 160. The display 160 displays the display screen according to the display data input from the display controller 132. The display controller 132 generates, for example, a prediction accuracy display screen as a display screen representing prediction accuracy information for each target variable. The display controller 132 determines a target variable for displaying prediction accuracy information according to an operation on the prediction accuracy display screen. For example, the display controller 132 changes a display target in a predetermined order whenever an operation is detected. The display controller 132 may include and display a selection screen showing a list of candidates to be displayed on the display screen, and may select the candidates instructed according to an operation as the display target. The user can visually recognize the prediction accuracy display screen displayed on the display 160 and ascertain the prediction accuracy of different learning models for each target variable. The display controller 132 may cause the display 160 to display a result of the verification of the first verification for all the data sets included in the verification data ID and a result of the verification of the second verification for the data set for each classification in the verification data ID. In addition, the display controller 132 causes the display 160 to display a graphical user interface (GUI) for receiving various input operations from the user.

The verifier 130 may select one or more types of index values from a plurality of types of prediction accuracy index values set in advance for each target variable according to an operation. When the plurality of types of index values are applied, the display controller 132 may change a type of a prediction accuracy index value to be output according to an operation, or may output these types of index values at the same time.

The storage 140 stores various types of data temporarily or permanently. The storage 140 stores, for example, learning source data OD, training data TD, verification data ID, a machine learning model (parameter), and the like.

The input and output unit 150 allows various types of input data to be input to or output from other devices.

Instead of outputting various types of display data to the display 160, the display controller 132 may output them to another device (another display device, a terminal device of the user, and the like) via the input and output unit 150.

Next, a hardware configuration example of the learning device 10 according to the present embodiment will be described. FIG. 4 is a schematic block diagram which shows a hardware configuration example of the learning device 10 according to the present embodiment. The learning device 10 includes, for example, a processor 152, an operation input unit 158, a display 160, a main memory 162, a program storage 164, an auxiliary storage 166, and an interface 168. The processor 152, the operation input unit 158, the display 160, the main memory 162, the program storage 164, the auxiliary storage 166, and the interface 168 are connected by a bus, and are capable of inputting and outputting various types of data to and from each other.

The processor 152 executes arithmetic processing instructed by an instruction written in various types of programs. The processor 152 controls an overall operation of the learning device 10. The processor 152 is, for example, a central processing unit (CPU). In the present embodiment, executing arithmetic processing instructed by an instruction written in a program may be referred to as “executing a program.”

The operation input unit 158 is capable of receiving an operation by the user, generates an operation signal according to the received operation, and outputs it to the processor 152. Various types of operation information are instructed by the operation signal. The operation input unit 158 may have general-purpose members such as a mouse, a touch sensor, and a keyboard, or may have dedicated members such as a button and a dial.

The display 160 displays a display screen according to the input display data. The display 160 may be any one of a liquid crystal display, an organic electroluminescent display, and the like.

The main memory 162 is a writable memory used as a reading area for an execution program of the processor 152 or as a work area for writing processing data of the execution program. The main memory 162 includes, for example, a random access memory (RAM).

The program storage 164 stores system firmware such as a basic input output system (BIOS), firmware for various devices, other programs, and setting information required for execution of these programs. The program storage 164 includes, for example, a read only memory (ROM).

The auxiliary storage 166 permanently stores various data and programs in a rewritable manner. The auxiliary storage 166 may be, for example, any one of a hard disk drive (HDD) and a solid-state drive (SSD).

The interface 168 connects to other devices by wire or wirelessly via a network so that various types of data can be input and output. The interface 168 includes one or both of an input and output interface and a communication interface.

The processor 152 and the main memory 162 correspond to the minimum hardware used to realize the computer system of the learning device 10. The processor 152 mainly realizes functions of the arithmetic processor 120 by executing a predetermined program in cooperation with the main memory 162 and other hardware. The main memory 162, the program storage 164, and the auxiliary storage 166 realize main functions of the storage 140. The interface 168 realizes main functions of the input and output unit 150.

### <Processing Flow>

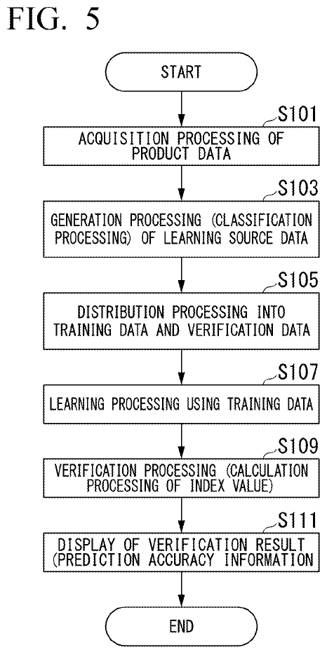

A processing flow of the learning device 10 will be described below. FIG. 5 is a flowchart which shows an example of a flow of processing of a learning device according to the present embodiment. The processing shown in FIG. 5 is started, for example, when the user inputs an instruction to start learning processing via the operation input unit 158 of the learning device 10.

First, the acquirer 122 acquires, for example, product data from an external device such as a product database (step S101). Alternatively, the product data is stored in a removable storage medium such as a USB, a DVD, or a CD-ROM, and the acquirer 122 may acquire product data by attaching this storage medium to a drive device provided in the learning device 10. This product data includes a plurality of data sets that are pairs of explanatory variables that indicate product materials or design matters and target variables that indicate product performance.

Next, the classifier 124 performs classification processing based on a product type on each data set included in the acquired product data, and generates the learning source data OD, which is a classified data set (step S103). The classifier 124 performs classification processing by, for example, assigning a classification (for example, a sample name) based on the product type to each data set. The classifier 124 stores the generated learning source data in the storage 140. For example, the sample name has a format of “type number_serial number.”

Next, the distributor 126 distributes the learning source data OD into the training data TD and the verification data ID on the basis of the classification (for example, the sample name) assigned to the learning source data OD (step S105). The distributor 126 distributes (evenly distributes) the learning source data OD into the training data TD and the verification data ID on the basis of the classification so as to maintain the proportion of a data set for each product type in the learning source data OD. The distributor 126 stores the distributed training data TD and verification data ID in the storage 140.

Next, the model learner 128 performs learning processing using the training data TD to generate a machine learning model (step S107). The model learner 128 uses the explanatory variables of a data set included in the training data TD as an input, and performs learning processing such that the evaluation value of the predetermined loss function that indicates the magnitude of the difference between the predicted values of a group of target variables calculated using the learning model and the actual measured values of target variables of the data set included in the training data TD decreases as a whole of the training data TD.

Next, the verifier 130 uses the verification data ID to verify the prediction accuracy of the machine learning model (step S109). The verifier 130 performs accuracy verification by comparing the predicted values of the target variables calculated using the machine learning model and the actual measured values of the target variables included in the verification data ID. The verifier 130 calculates the magnitude of the difference between the calculated predicted values and the actual measured values, that is, an index value (score) indicating the prediction accuracy. The verifier 130 aggregates the calculated index values of the prediction accuracy and generates prediction accuracy information indicating the aggregated prediction accuracy. The verifier 130 may use, for example, statistic of any one of the coefficient of determination (R²), the mean square error (MSE), the root mean square error (RMSE), the mean absolute error (MAE), the mean absolute percentage error (MAPE), the symmetric mean absolute percentage error (SMAPE), the maximum error ratio (MER), and the like, as an index value.

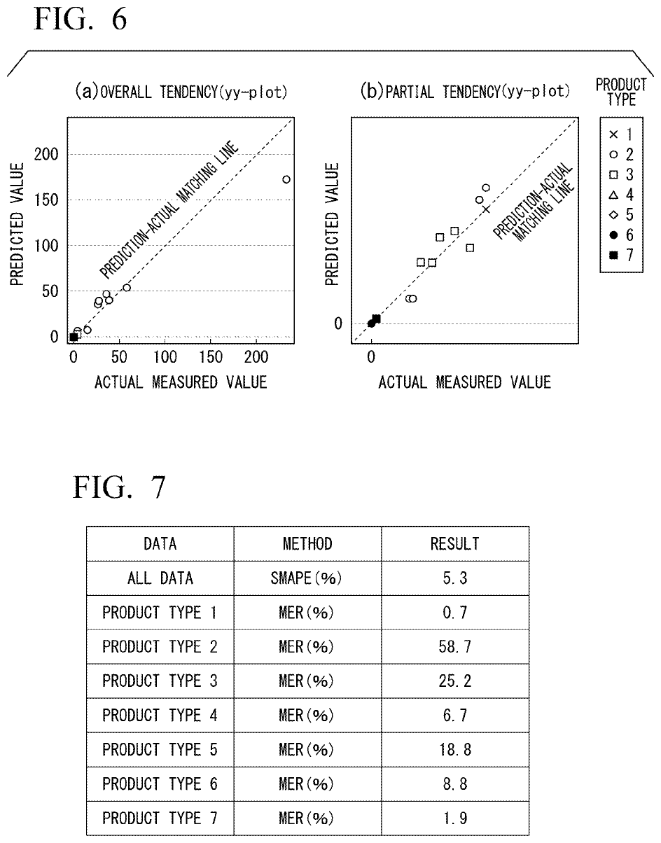

Next, the display controller 132 causes the display 160 to display prediction accuracy information, which is a result of the verification (step S111). FIG. 6 is a diagram which shows an example of the result of the verification (prediction accuracy information) according to the present embodiment. In FIG. 6, a corresponding relationship between the predicted values of the target variables calculated using the machine learning model and the actual measured values of the target variables included in the verification data ID is shown for each product type. As a plot is closer to a “prediction-actual matching line” where the predicted values and the actual measured values match, it indicates a higher prediction accuracy. An overall tendency (yy-plot) in FIG. 6 (a) represents entirety of the predicted values and the actual measured values. On the other hand, a partial tendency (yy-plot) in FIG. 6 (b) represents a partial range of the predicted values and the actual measured values (for example, a range of values from 0 to 10 of the predicted values and the actual measured values in FIG. 6 (a)). By checking such verification results (prediction accuracy information) displayed on the display 160, the user can check how much the predicted values and the actual measured values match for each product type, and verify accuracy of the machine learning model.

In addition, FIG. 7 is a diagram which shows another example of the verification results (prediction accuracy information) according to the present embodiment. FIG. 7 shows index values (statistical indicators) calculated using the predicted values and the actual measured values. In FIG. 7, a result of the symmetric mean absolute percentage error (SMAPE) is shown as an index value (a method) for all data of the verification data ID, and results of the maximum error ratio (MER) are shown as index values (methods) for individual data for each product type of the verification data ID. By checking such verification results (prediction accuracy information) displayed on the display 160, the user can check how much the predicted values and the actual measured values match for each product type, and verify the accuracy of the machine learning model. Note that the user can freely change an index value (a type of a statistical index) to be calculated by inputting an instruction via the operation input unit 158. As described above, processing of this flowchart is completed.

As described above, the learning device 10 according to the present embodiment includes the classifier 124 that classifies product data including a plurality of data sets that are pairs of explanatory variables indicating product materials or design matters and target variables indicating the performance of a product for each predetermined classification to generate the learning source data OD, the distributor 126 that distributes the learning source data OD into the training data TD and the verification data ID, the model learner 128 that generates a machine learning model on the basis of the training data TD, and the verifier 130 that compares the target variables included in the verification data ID and the target variables predicted by the machine learning model on the basis of the explanatory variables of the verification data, and the distributor 126 distributes learning source data such that the proportion of a data set for each classification in the learning source data OD corresponds to the proportion of a data set for each classification in the training data TD and the proportion of a data set for each classification in the verification data ID, thereby appropriately generating and verifying a machine learning model that performs performance prediction of a plurality of types of products. In particular, it is possible to suppress overfitting for the plurality of types of products and to prevent accuracy verification from being performed with biased data.

Although one embodiment of the present invention has been described above in detail with reference to the drawings, the specific configuration is not limited to that described above, and various design changes and the like may be made within a range not departing from the gist of the present invention.

What is claimed is:

1. A learning device including a processor configured to execute a program to:
generate learning source data by classifying product data, which includes a plurality of data sets that are pairs of explanatory variables indicating product materials or design matters and target variables indicating performance of the product, into each predetermined classification;
distribute the learning source data into training data and verification data;
generate a machine learning model on the basis of the training data; and
compare a target variable included in the verification data and a target variable predicted by the machine learning model on the basis of explanatory variables of the verification data,
wherein the processor is configured to execute the program to distribute the learning source data to make a proportion of a data set for each classification in the learning source data correspond to a proportion of the data set for each classification in the training data and a proportion of the data set for each classification in the verification data.

2. The learning device according to claim 1,
wherein the processor is configured to execute the program to perform both first verification for all data sets included in the verification data and second verification for the data sets for each classification in the verification data.

3. The learning device according to claim 2,
wherein the processor is configured to execute the program to perform the first verification and the second verification using different index values.

4. The learning device according to claim 1,
wherein the processor is configured to execute the program to distribute the learning source data to make the proportion of the data set for each classification in the learning source data be equal to the proportion of the data set for each classification in the training data and the proportion of the data set for each classification in the verification data.

5. The learning device according to claim 1,
wherein the processor is configured to execute the program to distribute the data set for each classification in the learning source data into the training data and the verification data in a predetermined proportion.

6. The learning device according to claim 1,
wherein the processor is configured to execute the program to classify the product data into classifications determined according to a use of the product.

7. The learning device according to claim 1,
wherein the processor is configured to execute the program to classify the product data into classifications determined according to a shape of the product.

8. The learning device according to claim 1,
wherein the processor is configured to execute the program to classify the product data into classifications determined according to a manufacturing method of the product.

9. The learning device according to claim 1,
wherein the processor is configured to execute the program to calculate a plurality of types of index values using a target variable included in the verification data and a target variable predicted by the machine learning model.

10. The learning device according to claim 2,
wherein the processor is further configured to execute the program to cause a display to display a verification result of the first verification and a verification result of the second verification.

11. The learning device according to claim 1,
wherein the product is a battery.

12. A learning method comprising:
by a computer,
generating learning source data by classifying product data, which includes a plurality of data sets that are pairs of explanatory variables indicating product materials or design matters and target variables indicating performance of the product, into each predetermined classification;
distributing the learning source data into training data and verification data;
generating a machine learning model on the basis of the training data; and
comparing a target variable included in the verification data and a target variable predicted by the machine learning model on the basis of explanatory variables of the verification data,
wherein
the learning source data is distributed to make a proportion of a data set for each classification in the learning source data correspond to a proportion of the data set for each classification in the training data and a proportion of the data set for each classification in the verification data.

13. A computer-readable non-transitory storage medium storing a program causing a computer to execute:
generating learning source data by classifying product data, which includes a plurality of data sets that are pairs of explanatory variables indicating product materials or design matters and target variables indicating performance of the product, into each predetermined classification,
distributing the learning source data into training data and verification data,
generating a machine learning model on the basis of the training data, and
comparing a target variable included in the verification data and a target variable predicted by the machine learning model on the basis of explanatory variables of the verification data,
wherein the program causes the learning source data to be distributed to make a proportion of a data set for each classification in the learning source data correspond to a proportion of the data set for each classification in the training data and a proportion of the data set for each classification in the verification data.
